(19) United States
(12) Patent Application Publication
(10) Pub. No.: US 2021/0129589 A1
(43) Pub. Date: May 6, 2021

(54) PLY FOR A TIRE

(71) Applicant: The Goodyear Tire & Rubber Company, Akron, OH (US)

(72) Inventors: Frank Anthony Kmiecik, Akron, OH (US); Alex James Elchert, Stow, OH (US); Matthew Ray Cappelli, Canal Fulton, OH (US); Christopher Daniel Pfeiffer, Akron, OH (US); Minwu Yao, Stow, OH (US)

(21) Appl. No.: 16/668,548

(22) Filed: Oct. 30, 2019

(51) Int. Cl. B60C 9/04; B29D 30/38

(52) U.S. Cl. CPC B60C 9/04; B29D 2030/381; B29D 30/38

(57) ABSTRACT

A tire includes a pair of axially spaced apart annular bead cores, a carcass ply extending around both bead cores, a tread for engaging a contact surface and being disposed radially outward of the carcass ply, and a belt structure disposed radially between the carcass ply and the tread. The carcass ply includes a plurality of cords embedded in a polymer matrix. The carcass ply has a first radially upper surface and a second radially lower surface disposed opposite the first surface. The first surface defines first portions and second portions interspaced between each first portion. Each first portion has a thickness greater than each second portion thereby forming throated portions between each cord of the plurality of cords.

### FIELD OF THE INVENTION

The present invention relates to producing a ply capable of enhancing performance of pneumatic or non-pneumatic tires.

### BACKGROUND OF THE INVENTION

A ply may conventionally be used for various rubber products, such as tires. The ply may be formed in such a manner that cords may be arranged in an array and coated with a topping rubber. The ply may thus be a thinly array of cords.

### SUMMARY OF THE INVENTION

A tire in accordance with the present invention includes a pair of axially spaced apart annular bead cores, a carcass ply extending around both bead cores, a tread for engaging a contact surface and being disposed radially outward of the carcass ply, and a belt structure disposed radially between the carcass ply and the tread. The carcass ply includes a plurality of cords embedded in a polymer matrix. The carcass ply has a first radially upper surface and a second radially lower surface disposed opposite the first surface. The first surface defines first portions and second portions interspaced between each first portion. Each first portion has a thickness greater than each second portion thereby forming throated portions between each cord of the plurality of cords.

According to another aspect of the tire, each first portion joins with an adjacent second portion forming a linear conjunction.

According to still another aspect of the tire, each second portion is defined by a midpoint between two cords on one lateral side of a cord and a midpoint between two cords on the opposite lateral side of the cord.

According to yet another aspect of the tire, the first surface has a corduroy appearance.

According to still another aspect of the tire, the second surface has second cylindrical portions with each of the second cylindrical portions being partially concentric with a cylindrical outer surface of an adjacent cord.

According to yet another aspect of the tire, each second cylindrical portion joins with an adjacent second cylindrical portion forming a linear conjunction.

According to still another aspect of the tire, each second cylindrical portion is defined by a midpoint between two cords on one lateral side of a cord and a midpoint between two cords on the opposite lateral side of the cord.

According to yet another aspect of the tire, the second surface has a corduroy appearance.

According to still another aspect of the tire, the belt structure has a first radially upper belt surface and a second radially lower belt surface disposed opposite the first belt surface, the first belt surface having first belt cylindrical portions with each of the first belt cylindrical portions being partially concentric with a cylindrical outer surface of an adjacent belt cord.

According to yet another aspect of the tire, the first belt surface has a corduroy appearance.

A method, in accordance with the present invention, produces a corduroy ply. The method includes the steps of: concentrically attaching a first topping rubber to a periphery of each of a plurality of cords; forming an array of cords coated with the first topping rubber; concentrically attaching a second topping rubber to a periphery of each of the plurality of cords; and forming a cord ply having a corduroy first surface and a corduroy second surface opposite the first corduroy surface.

According to another aspect of the method, a further step includes modifying a first planar surface and a second planar surface.

According to still another aspect of the method, a further step includes removing rubber from a first planar surface of the cord ply and a second planar surface of the cord ply.

According to yet another aspect of the method, a further step includes calendering the first topping rubber and the second topping rubber.

According to still another aspect of the method, a further step includes removing throat material between each cord of the plurality of cords.

According to yet another aspect of the method, pressure of the first topping rubber in a topping chamber is 5,000 kPa or higher.

According to still another aspect of the method, pressure of the second topping rubber in the topping chamber is 5,000 kPa or higher.

According to yet another aspect of the method, a time interval between the attaching steps is 10 minutes or less.

According to still another aspect of the method, the first topping rubber has the same rubber composite as that of the second topping rubber.

According to yet another aspect of the method, the first topping rubber has a rubber composite with greater complex elastic modulus than that of the second topping rubber.

### Definitions

As used herein and in the claims:

“Apex” means an elastomeric filler located radially above the bead core and between the plies and the turnup ply.

“Annular” means formed like a ring.

“Aspect ratio” means the ratio of a tire section height to its section width.

“Aspect ratio of a bead cross-section” means the ratio of a bead section height to its section width.

“Asymmetric tread” means a tread that has a tread pattern not symmetrical about the centerplane or equatorial plane (EP) of the tire.

“Axial” and “axially” refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane (EP) of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25° to 65° angle with respect to equatorial plane (EP) of the tire. If multiple plies are present, the ply cords run at opposite angles in alternating layers.

“Breakers” means at least two annular layers or plies of parallel reinforcement cords having the same angle with reference to the equatorial plane (EP) of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls, and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” and “circumferentially” mean lines or directions extending along the perimeter of the surface of the annular tire parallel to the equatorial plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane (EP). The “cord angle” is measured in a cured but uninflated tire.

“Corduroy” means a surface composed of linear tufts (such as portions 21) and channels/throats between the tufts. The surface may look as if it is made from multiple cords laid parallel to each other.

“Crown” means that portion of the tire within the width limits of the tire tread.

“Denier” means the weight in grams per 9000 meters (unit for expressing linear density). “Dtex” means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Evolving tread pattern” means a tread pattern, the running surface of which, which is intended to be in contact with the road, evolves with the wear of the tread resulting from the travel of the tire against a road surface, the evolution being predetermined at the time of designing the tire, so as to obtain adhesion and road handling performances which remain substantially unchanged during the entire period of use/wear of the tire, no matter the degree of wear of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made, that forms the basic element of filaments; characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Footprint” means the contact patch or area of contact of the tire tread with a flat surface at zero speed and under normal load and pressure.

“Gauge” refers generally to a measurement, and specifically to a thickness measurement.

“Groove” means an elongated void area in a tread that may extend circumferentially or laterally about the tread in a straight, curved, or zigzag manner. Circumferentially and laterally extending grooves sometimes have common portions. The “groove width” may be the tread surface occupied by a groove or groove portion divided by the length of such groove or groove portion; thus, the groove width may be its average width over its length. Grooves may be of varying depths in a tire. The depth of a groove may vary around the circumference of the tread, or the depth of one groove may be constant but vary from the depth of another groove in the tire. If such narrow or wide grooves are of substantially reduced depth as compared to wide circumferential grooves, which they interconnect, they may be regarded as forming “tie bars” tending to maintain a rib-like character in the tread region involved. As used herein, a groove is intended to have a width large enough to remain open in the tires contact patch or footprint.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“Inboard side” means the side of the tire nearest the vehicle when the tire is mounted on a wheel and the wheel is mounted on the vehicle.

“LASE” is load at specified elongation.

“Lateral” means an axial direction.

“Lay length” means the distance at which a twisted filament or strand travels to make a 360° rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Net contact area” means the total area of ground contacting elements between defined boundary edges as measured around the entire circumference of the tread.

“Net-to-gross ratio” means the total area of ground contacting tread elements between lateral edges of the tread around the entire circumference of the tread divided by the gross area of the entire circumference of the tread between the lateral edges.

“Non-directional tread” means a tread that has no preferred direction of forward travel and is not required to be positioned on a vehicle in a specific wheel position or positions to ensure that the tread pattern is aligned with the preferred direction of travel. Conversely, a directional tread pattern has a preferred direction of travel requiring specific wheel positioning.

“Normal load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Outboard side” means the side of the tire farthest away from the vehicle when the tire is mounted on a wheel and the wheel is mounted on the vehicle.

“Ply” means a cord-reinforced layer of rubber-coated radially deployed or otherwise parallel cords.

“Radial” and “radially” mean directions radially toward or away from the axis of rotation of the tire.

“Radial ply structure” means the one or more carcass plies or which at least one ply has reinforcing cords oriented at an angle of between 65° and 90° with respect to the equatorial plane (EP) of the tire.

“Radial ply tire” means a belted or circumferentially-restricted pneumatic tire in which at least one ply has cords which extend from bead to bead and the ply is laid at cord angles between 65° and 90° with respect to the equatorial plane (EP) of the tire.

“Rib” means a circumferentially extending strip of rubber on the tread which is defined by at least one circumferential groove and either a second such groove or a lateral edge, the strip being laterally undivided by full-depth grooves.

“Rivet” means an open space between cords in a layer.

“Section height” means the radial distance from the nominal rim diameter to the outer diameter of the tire at its equatorial plane (EP).

“Section width” means the maximum linear distance parallel to the axis of the tire and between the exterior of its sidewalls when and after it has been inflated at normal pressure for 24 hours, but unloaded, excluding elevations of the sidewalls due to labeling, decoration, or protective bands.

“Self-supporting run-flat” means a type of tire that has a structure wherein the tire structure alone is sufficiently strong to support the vehicle load when the tire is operated in the uninflated condition for limited periods of time and limited speed. The sidewall and internal surfaces of the tire may not collapse or buckle onto themselves due to the tire structure alone (e.g., no internal structures).

“Sidewall insert” means elastomer or cord reinforcements located in the sidewall region of a tire. The insert may be an addition to the carcass reinforcing ply and outer sidewall rubber that forms the outer surface of the tire.

“Sidewall” means that portion of a tire between the tread and the bead.

“Sipe” or “incision” means small slots molded into the tread elements of the tire that subdivide the tread surface and improve traction; sipes may be designed to close when within the contact patch or footprint, as distinguished from grooves.

“Spring rate” means the stiffness of tire expressed as the slope of the load deflection curve at a given pressure.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier).

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread element” or “traction element” means a rib or a block element.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Vertical deflection” means the amount that a tire deflects under load.

“Yarn” is a generic term for a continuous strand of textile fibers or filaments. Yarn occurs in the following forms: (1) a number of fibers twisted together; (2) a number of filaments laid together without twist; (3) a number of filaments laid together with a degree of twist; (4) a single filament with or without twist (monofilament); and (5) a narrow strip of material with or without twist.

### BRIEF DESCRIPTION OF THE DRAWINGS

The present invention will be described by way of example and with reference to the accompanying drawings, in which:

FIG. 1 schematically shows an example apparatus for producing a ply in accordance with the present invention;

FIG. 2 schematically shows an enlarged perspective view of part of the example apparatus of FIG. 1; and

FIG. 3 schematically shows a cross-section construction of a ply in accordance with the present invention.

### DETAILED DESCRIPTION OF EXAMPLES OF THE PRESENT INVENTION

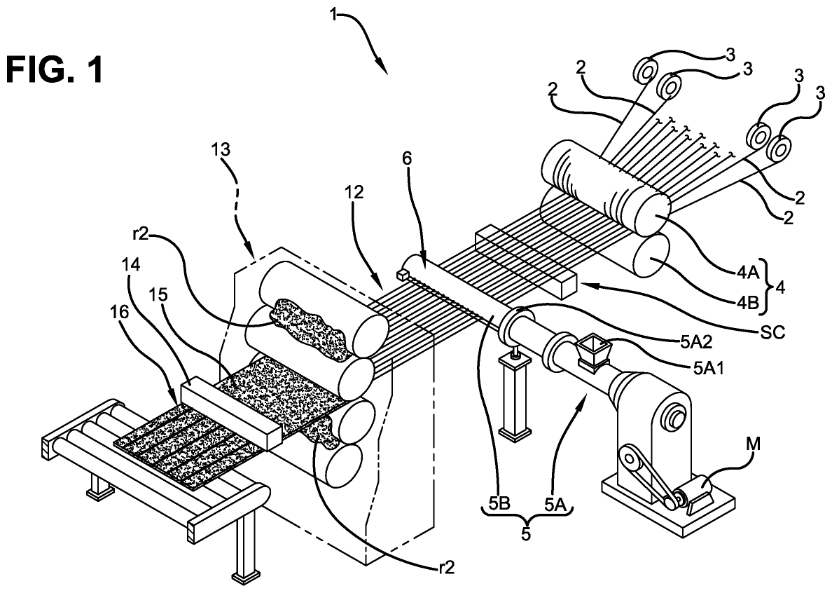

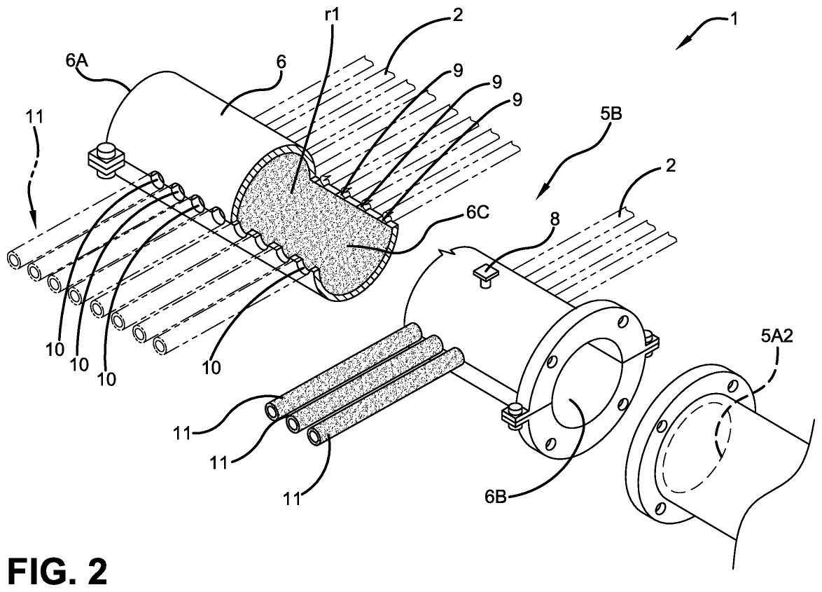

FIG. 1 shows an example apparatus 1 for producing a ply in accordance with the present invention. The ply may be used in any structure of a tire, such as carcass, belt, overlay, flipper, chipper, etc. This apparatus 1 is only one example and the apparatus may not be limited to the specific structure of FIGS. 1-2. Cords 2 may be pulled out from spools 3 arranged in parallel to each other and supplied to a first topping apparatus 5. A suitable structure for the cords 2 is not limited, and the structure may be selected in accordance with the ply, such as 1×5, 1×4, 1×3, 2+2, 2+3, monofilament, etc. Although the cords 2 are shown as monofilaments in FIGS. 1-3, a stranded cord comprising a plurality of strands/filaments may alternatively be used. The cords 2 may be constructed of steel, carbon fiber, resin, rayon, aramid, glass fiber, rayon, and/or other suitable material.

When the cords 2 pass through an arranging roll 4, the cords 2 may be substantially in parallel to each other. The arranging roll 4 may include rotatable roll bodies 4A, 4B which sandwich the cords 2 from above and below. In the example shown, an outer peripheral surface of at least one of the roll bodies may be formed with a guide groove into which a portion of the cords 2 may be fitted. The guide groove may be formed in the circumferential direction of the roll bodies 4A, 4B. Thus, a plurality of the cords 2 may discharge from the arranging roll 4 smoothly and without resistance. Alternatively, a comb-like body with slit-like guide hole may be provided instead of the roll 4.

In the example of FIGS. 1-2, the first topping apparatus 5 includes a small rubber extruding portion 5A and a rubber attaching tool 5B mounted on a tip end of the rubber extruding portion. The rubber extruding portion 5A may include an input port 5A1 into which material of first topping rubber is supplied and an extruding port 5A2 from which kneaded and plasticized first topping rubber is discharged to the cords 2. The rubber extruding portion 5A may include a screw-type rubber extruder with a screw shaft rotated by a motor M. The rubber attaching tool 5B may include a pipe-like body 6 connected to the extruding port 5A2 of the rubber extruding portion 5A.

The pipe-like body 6 may include a hollow topping chamber 6C therein. A distal end 6A of the pipe-like body 6 may be closed and a posterior end 6B of the pipe-like body 6 may include an opening which may communicate with the extruding port 5A2. If the posterior end 6B of the pipe-like body 6 is fixed to the rubber extruding portion 5A, using a flange for example, first topping rubber may supply the topping chamber 6C of the pipe-like body 6 under a predetermined pressure. The pipe-like body 6 may be longitudinally split into two pieces for facilitating maintenance of the topping chamber 6C.

As shown in FIG. 2, the pipe-like body 6 may include a plurality of first guiding holes 9 at its upstream wall surface through which the cords 2 may pass. The first holes 9 may be formed at distances from one another in a longitudinal direction of the pipe-like body 6. The base body 6 may also include second coating holes 10 at its downstream wall surface corresponding to the first holes 9. The second holes 10 may be concentric with the first holes 9 and have a diameter greater than a diameter of the first holes 9. The rubber attaching tool 5B may further include a pressure sensor 8 for detecting pressure in the topping chamber 6C. A signal from the pressure sensor 8 may be transmitted to a control apparatus (not shown) of the rubber extruding portion 5A. A rubber amount for supplying the rubber extruding portion 5A may thereby automatically control the rubber pressure of the topping chamber 6C and maintain the pressure at a predetermined optimal value.

The cords 2, arranged in parallel to one another by the roll 4, may thus pass through the topping chamber 6C from the first holes 9 of the pipe-like body 6 to the second holes 10. The cords 2 may be pulled out straightly such that the cords 2 align with respect to a coincident center of each of the first holes 9 and second holes 10. In the topping chamber 6C, first topping rubber r1 supplied under the predetermined rubber pressure may permeate/fill in a gap between the cords 2 and attach to a periphery of the cords. In the second hole 10, the first topping rubber r1 attached to the cords 2 may be sliced off except a thin coating layer 11 concentrically attached to periphery of the cords.

Since the cords 2 pass through the high pressure first topping rubber r1, even if the passing speed is fast, the first topping rubber r1 may sufficiently and effectively permeate the fine gap between the cords 2. As stated above, the pressure in the topping chamber 6C may be controlled in a desired range by the pressure sensor 8. Therefore, the attaching efficiency of the first topping rubber r1 to the cords 2 may be achieved.

The pressure in the topping chamber 6C may be 5,000 kPa, 10,000 kPa, or higher. If the pressure in the topping chamber 6C is less than 5,000 kPa, the attaching or permeating effect of first topping rubber r1 with respect to the cords 2 may be less than acceptable. If the pressure is excessively high, the first topping rubber r1 may flow out undesirably from the first and second holes 9, 10. Also, resistance caused when the cords 2 pass through the first topping rubber r1 may become greater and the productivity deteriorated. The speed of the cords 2 may be in a range of 5 to 30 m/min or in a range of 10 to 30 m/min.

The diameter of the first holes 9 may be in a range of 101% to 107% of the outer diameter of the cords 2 or in a range of 103% to 105% thereof. If the diameter of the first holes 9 is less than 101% of the outer diameter of the cords 2, the cords may be damaged. If the diameter exceeds 107%, centering of the cords 2 may become problematic and an amount of topping rubber flowing out from the gap between the cords may become excessive.

The diameter of the second holes 10 may be in a range of 102% to 110% of the outer diameter of the cords or in a range of 103% to 105% thereof. If the diameter of the second holes 10 is less than 102% of the outer diameter of the cords, the coating thickness of the first topping rubber r1 may become excessively small and may lead to peeling off of the first topping rubber. If the diameter exceeds 107%, the coating thickness may become excessively thick and undesirably increase the overall ply thickness. The coating thickness may be between 0.1 mm and 0.5 mm.

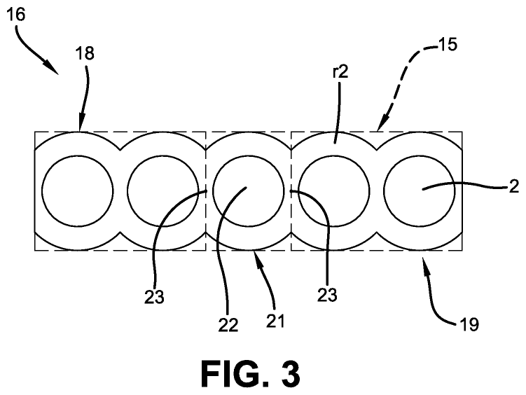

Next, a second topping step may attach a second topping rubber r2 to a surface of a cord array 12 in which the cords 2 and coating of first topping rubber r1 are arranged. Four calender rolls 13 may be used (FIG. 1). Both surfaces of the cord array 12 having rubber may be coated with second topping rubbers r2 and a sheet-like cord ply 15, such as that of FIG. 3, may be formed.

As shown in FIGS. 1 and 3 and in accordance with the present invention, a supplemental die 14 may be further included downstream of the calender rolls 13. The die 14 may include a die plate for modifying the planar upper and lower surfaces of the sheet like ply 15 such that the throated ply 16 of FIG. 3 is achieved. The die 14 may remove rubber r2 from the sheet-like ply 15 such that an upper surface 18 and a lower surface 19 of the throated ply 16 may have cylindrical portions 21 with each of the cylindrical portions being partially concentric with a cylindrical outer surface of its adjacent cord 2. The joining of each cylindrical portion 21 with an adjacent cylindrical portion may form a linear conjunction with each cylindrical portion being defined by a midpoint 23 between two cords on one side of a cord 22 and a midpoint 23 between two cords on the opposite side of the cord 22.

The design of the throated ply 16 may create a volume neutral ply (compared to traditional sheet-like ply 15) with rubber on top and bottom of the cord 22 and a notch or throat between each cord 2. This may result in a more even strain distribution of rubber within the ply 16 during tire shaping, which may produce a more even cord spacing in the cured tire. The upper and lower surfaces 18, 19 of the ply 16 may in one example thereby have an appearance similar to corduroy fabric (FIG. 3). Additionally, any geometry that creates a ply 16 with a varying gauge along the upper and lower surfaces 18, 19 may result in the even strain distribution described above.

Consequently, any example ply 16 with additional topping gauge placed immediately above and/or below each cord 22 and less gauge placed between the cords 22 may be such a geometry. Example geometries may further include saw-toothed, square-toothed, rectangular-toothed, non-concentric cylindrical, or any suitable repeating geometry that meets this description. Such a ply 16 may be used with any suitable tire, such as that disclosed in US 2002/0134482, incorporated herein by reference in its entirety.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed:

1. A tire comprising:
a pair of axially spaced apart annular bead cores;
a carcass ply extending around both bead cores;
a tread for engaging a contact surface, the tread being disposed radially outward of the carcass ply; and
a belt structure disposed radially between the carcass ply and the tread, the carcass ply including having a plurality of cords embedded in a polymer matrix, the carcass ply having a first radially upper surface and a second radially lower surface disposed opposite the first surface, the first surface defining first portions and second portions interspaced between each first portion, each first portion having a thickness greater than each second portion thereby forming throated portions between each cord of the plurality of cords.

2. The tire as set forth in claim 1 wherein each first portion joins with an adjacent second portion forming a linear conjunction.

3. The tire as set forth in claim 1 wherein each second portion is defined by a midpoint between two cords on one lateral side of a cord and a midpoint between two cords on the opposite lateral side of the cord.

4. The tire as set forth in claim 1 wherein the first surface has a corduroy appearance.

5. The tire as set forth in claim 1 wherein the second surface has second cylindrical portions with each of the second cylindrical portions being partially concentric with a cylindrical outer surface of an adjacent cord.

6. The tire as set forth in claim 5 wherein each second cylindrical portion joins with an adjacent second cylindrical portion forming a linear conjunction.

7. The tire as set forth in claim 5 wherein each second cylindrical portion is defined by a midpoint between two cords on one lateral side of a cord and a midpoint between two cords on the opposite lateral side of the cord.

8. The tire as set forth in claim 5 wherein the second surface has a corduroy appearance.

9. The tire as set forth in claim 1 wherein the belt structure has a first radially upper belt surface and a second radially lower belt surface disposed opposite the first belt surface, the first belt surface having first belt cylindrical portions with each of the first belt cylindrical portions being partially concentric with a cylindrical outer surface of an adjacent belt cord.

10. The tire as set forth in claim 9 wherein the first belt surface has a corduroy appearance.

11. A method for producing a corduroy ply, the method comprises the steps of:
concentrically attaching a first topping rubber to a periphery of each of a plurality of cords;
forming an array of cords coated with the first topping rubber;
concentrically attaching a second topping rubber to a periphery of each of the plurality of cords; and
forming a cord ply having a corduroy first surface and a corduroy second surface opposite the first corduroy surface.

12. The method as set forth in claim 11 further including the step of modifying a first planar surface and a second planar surface.

13. The method as set forth in claim 11 further including the step of removing rubber from a first planar surface of the cord ply and a second planar surface of the cord ply.

14. The method as set forth in claim 11 further including the step of calendering the first topping rubber and the second topping rubber.

15. The method as set forth in claim 11 further including the step of removing throat material between each cord of the plurality of cords.

16. The method as set forth in claim 11 wherein pressure of the first topping rubber in a topping chamber is 5,000 kPa or higher.

17. The method as set forth in claim 16 wherein pressure of the second topping rubber in the topping chamber is 5,000 kPa or higher.

18. The method as set forth in claim 11 wherein a time interval between the attaching steps is 10 minutes or less.

19. The method as set forth in claim 11 wherein the first topping rubber has the same rubber composite as that of the second topping rubber.

20. The method as set forth in claim 11 wherein the first topping rubber has a rubber composite with greater complex elastic modulus than that of the second topping rubber.
